(19) United States
(12) Patent Application Publication
(10) Pub. No.: US 2012/0154199 A1
(43) Pub. Date: Jun. 21, 2012

(54) OMNI-DIRECTIONAL ANTENNA AT A SECONDARY SURVEILLANCE RADAR

(75) Inventor: Timothy P. Donovan, Groton, MA (US)

(73) Assignee: Raytheon Company, Waltham, MA (US)

(21) Appl. No.: 12/973,002

(22) Filed: Dec. 20, 2010

(51) Int. Cl. G01S 13/74

(52) U.S. Cl. 342/38

(57) ABSTRACT

In one aspect, a method includes sending an interrogation request using an omni-directional antenna at a secondary surveillance radar, receiving, from responding aircraft, interrogation responses comprising identity and altitude, determining a distance to each of the responding aircraft based on a time the interrogation request was sent and a time an interrogation response was received, receiving, from a primary radar, positions of tracks, correlating the distances of each responding aircraft with the positions of the tracks to form a set of candidates by position; and sending identity, altitude and position of a track if there is one candidate from the set of candidates.

### BACKGROUND

In air traffic control (ATC) system, a primary radar determines, for example, range and azimuth of an aircraft. The primary radar works in conjunction with a secondary surveillance radar (SSR). The SSR also determines range and azimuth, but additionally altitude and identity. The SSR does this by sending an interrogation message that the aircraft responds to with a message containing identity and altitude information. The aircraft responds to the interrogation message by sending a reply to the SSR using a transponder.

### SUMMARY

In one aspect, a method includes sending an interrogation request using an omni-directional antenna at a secondary surveillance radar, receiving, from responding aircraft, interrogation responses comprising identity and altitude, determining a distance to each of the responding aircraft based on a time the interrogation request was sent and a time an interrogation response was received, receiving, from a primary radar, positions of tracks, correlating the distances of each responding aircraft with the positions of the tracks to form a set of candidates by position; and sending identity, altitude and position of a track if there is one candidate from the set of candidates.

In another aspect, an apparatus includes circuitry to send an interrogation request using an omni-directional antenna at a secondary surveillance radar, receive, from responding aircraft, interrogation responses comprising identity and altitude, determine a distance to each of the responding aircraft based on a time the interrogation request was sent and a time an interrogation response was received, receive, from a primary radar, positions of tracks, correlate the distances of each responding aircraft with the positions of the tracks to form a set of candidates by position and send identity, altitude and position of a track if there is one candidate from the set of candidates.

In a further aspect, an article includes a non-transitory machine-readable medium that stores executable instructions that cause a machine to send an interrogation request using an omni-directional antenna at a secondary surveillance radar, receive, from responding aircraft, interrogation responses comprising identity and altitude, determine a distance to each of the responding aircraft based on a time the interrogation request was sent and a time an interrogation response was received, receive, from a primary radar, positions of tracks, correlate the distances of each responding aircraft with the positions of the tracks to form a set of candidates by position; and send identity, altitude and position of a track if there is one candidate from the set of candidates.

### DESCRIPTION OF THE DRAWINGS

FIG. 1A is a block diagram of an air traffic control (ATC) radar system.

FIGS. 1B and 1C are top views of examples of different panel array configurations.

FIG. 2 is a flowchart of an example of a process to use an omni-directional antenna in a secondary surveillance radar.

FIG. 3 is a computer on which the process of FIG. 2 may be implemented.

### DETAILED DESCRIPTION

Described herein are techniques for using a secondary surveillance radar (SSR) that includes an omni-directional antenna rather than a rotating directional antenna. Using an omni-directional antenna provides a low cost solution to air traffic control. In one particular example, the low cost solution includes an SSR working in conjunction with a primary radar that is a phased array radar having a panel architecture.

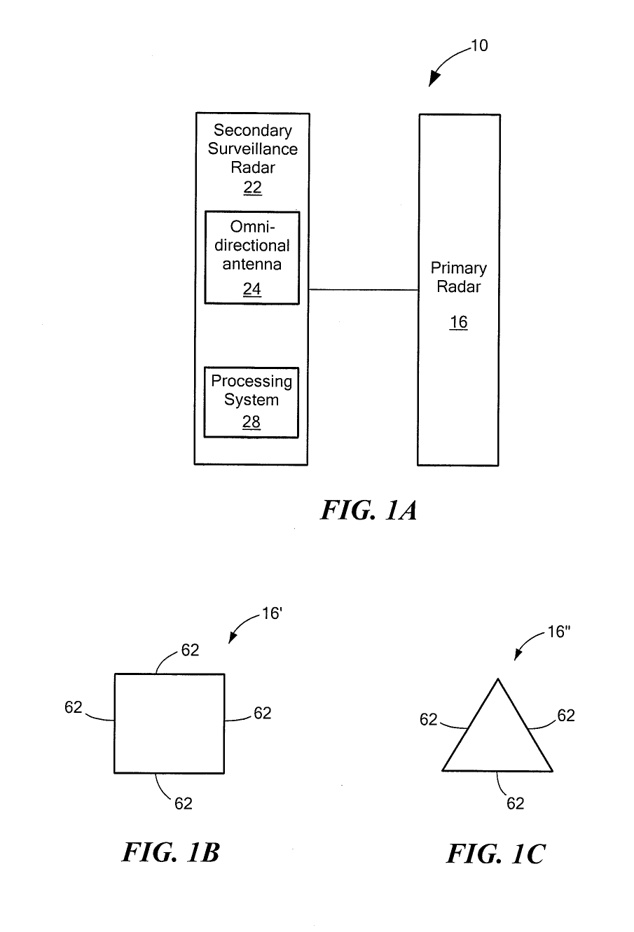

Referring to FIG. 1A, an air traffic control system 10 includes a primary radar 16 and a SSR 22. In one example, the primary radar 16 is a phased array radar having a panel array architecture. In another example, the primary radar 16 is a rotating radar. The SSR 22 includes an omni-directional antenna 24 and a processing system 28.

Referring to FIGS. 1B and 1C, the primary radar 16 may be arranged in any configuration that allows for 360° coverage. For example, the primary radar 16 may be configured as a phased array radar 16′ having panels 62 arranged in a square configuration as shown in FIG. 1B. In one example, the phased array radar is a phased array radar having a panel architecture such as one described in U.S. Patent Publication Number 20100066631, entitled “Panel Array,” published Mar. 18, 2010, which is incorporated herein in its entirety. In another example, the primary radar 16 may be configured as a phased array radar 16′ having panels 62 arranged in a triangular configuration as shown in FIG. 1C.

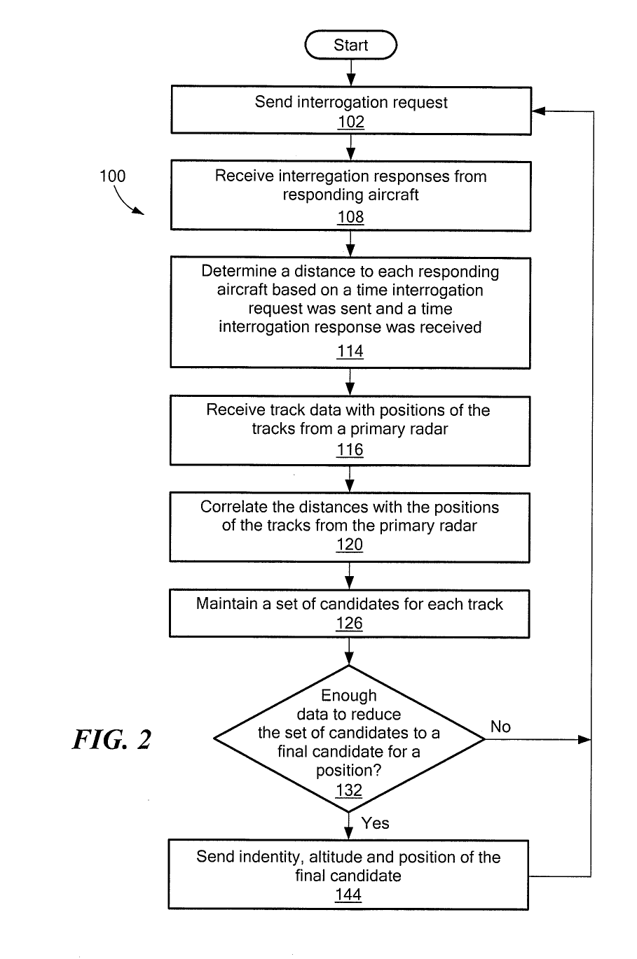

Referring to FIG. 2, one example of a process to use an omni-directional antenna in the SSR 22 is a process 100. Process 100 sends interrogation messages in all directions (102). For example, the SSR 22 sends the interrogation requests in all directions at 1.03 GHz using the omni-directional antenna 24. Process 100 receives interrogation responses (108). For example, the SSR 22 receives responses to the interrogation requests at 1.09 GHz from the transponders of responding aircraft.

Process 100 determines a distance to each responding aircraft based on a time an interrogation request was sent and a time an interrogation response was received (114). In one particular example, process 100 determines the distance to each responding aircraft based on the time the interrogation request was sent, the time the interrogation response was received and a delay. In one example, the delay is a fixed transponder delay. In one example, the fixed transponder delay is based on Radio Technical Commission for Aeronautics (RTCA) DO-181C.

Process 100 receives track data with positions of the tracks from the primary radar 16 (116) and correlates the distances to each responding aircraft to the positions of the tracks from the primary radar (16) (120). A track represents the current estimated position of an object based on multiple radar reports. In one example, a position of a track is designated in azimuth and range. In other examples, the position is designated by latitude and longitude or Cartesian coordinates in the radar plane.

In some instances, there may be more than one distance to a responding aircraft associated with a track. Each distance to a responding aircraft correlated to a track is a designated as a candidate for that position.

Process 100 maintains a set of candidates for each track (126). As data is collected, candidate distances will be eliminated as candidates for the position. If enough data is collected to reduce the set of candidates to a final candidate (132), process 100 sends the identity and altitude of the final candidate with the correlated position of the track (144). In one example, the identity is mode A and the altitude is mode C.

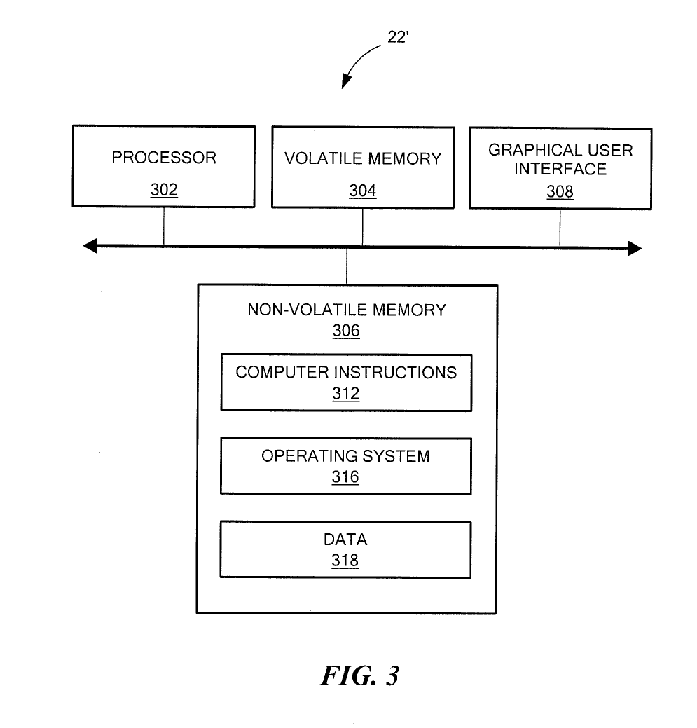

Referring to FIG. 3, an example of the processing system 28 is a computer 28′, which may be used to execute all or part of the process 100. The computer 28′ includes a processor 302, a volatile memory 304, a non-volatile memory 306 (e.g., hard disk), for example, and a graphical user interface (GUI) 308 (e.g., a mouse, a keyboard, a touch screen and so forth). In other examples of a computer 28′, the GUI 308 may not be included. Non-volatile memory 306 includes an operating system 316; data 318; and computer instructions 312 which are executed out of volatile memory 304 to perform all or part of process 100.

The processes described herein (e.g., process 100) are not limited to use with the hardware and software of FIG. 3; they may find applicability in any computing or processing environment and with any type of machine or set of machines that is capable of running a computer program. The processes may be implemented in hardware, software, or a combination of the two. The processes may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 100, for example, and to generate output information.

The processes described herein are not limited to the specific embodiments described herein. For example, the processes are not limited to the specific processing order of the process steps in FIG. 2. Rather, any of the processing steps of FIG. 2 may be re-ordered, combined or removed, performed in parallel or in serial, as necessary, to achieve the results set forth above.

Process steps in FIG. 2 associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

While the invention is shown and described in conjunction with a particular embodiment having an illustrative architecture having certain components in a given order, it is understood that other embodiments well within the scope of the invention are contemplated having more and fewer components, having different types of components, and being coupled in various arrangements. Such embodiments will be readily apparent to one of ordinary skill in the art. All documents cited herein are incorporated herein by reference. Other embodiments not specifically described herein are also within the scope of the following claims.

What is claimed is:

1. A method, comprising:
sending an interrogation request using an omni-directional antenna at a secondary surveillance radar;
receiving, from responding aircraft, interrogation responses comprising identity and altitude;
determining a distance to each of the responding aircraft based on a time the interrogation request was sent and a time an interrogation response was received;
receiving, from a primary radar, positions of tracks;
correlating the distances of each responding aircraft with the positions of the tracks to form a set of candidates by position; and
sending identity, altitude and position of a track if there is one candidate from the set of candidates.

2. The method of claim 1, further comprising:
continually receiving the interrogation responses and the positions of tracks; and
reducing the set of candidates by position to one candidate.

3. The method of claim 1 wherein receiving, from a primary radar, positions of tracks comprises receiving positions of tracks from a primary radar that is a phased array radar having a panel array architecture.

4. The method of claim 1 wherein receiving, from a primary radar, positions of tracks comprises receiving positions of tracks from a primary radar that is a rotating radar.

5. The method of claim 1 wherein determining a distance to each of the responding aircraft based on a time the interrogation request was sent and a time an interrogation response was received comprises determining a distance to each of the responding aircraft based on the time the interrogation request was sent, the time the interrogation response was received and a transponder delay.

6. An apparatus comprising:
circuitry to:
send an interrogation request using an omni-directional antenna at a secondary surveillance radar;
receive, from responding aircraft, interrogation responses comprising identity and altitude;
determine a distance to each of the responding aircraft based on a time the interrogation request was sent and a time an interrogation response was received;
receive, from a primary radar, positions of tracks;
correlate the distances of each responding aircraft with the positions of the tracks to form a set of candidates by position; and
send identity, altitude and position of a track if there is one candidate from the set of candidates.

7. The apparatus of claim 6 wherein the circuitry comprises at least one of a processor, a memory, programmable logic and logic gates.

8. The apparatus of claim 6, further comprising circuitry to:
continually receive the interrogation responses and the positions of tracks; and
reduce the set of candidates by position to one candidate.

9. The apparatus of claim 6 wherein the circuitry to receive, from a primary radar, positions of tracks comprises circuitry to receive positions of tracks from a primary radar that is a phased array radar having a panel array architecture.

10. The apparatus of claim 6 wherein the circuitry to receive, from a primary radar, positions of tracks comprises circuitry to receive positions of tracks from a primary radar that is a rotating radar.

11. The apparatus of claim 6 wherein the circuitry to determine a distance to each of the responding aircraft based on a time the interrogation request was sent and a time an interrogation response was received comprises circuitry to determine a distance to each of the responding aircraft based on the time the interrogation request was sent, the time the interrogation response was received and a transponder delay.

12. An article comprising:
a non-transitory machine-readable medium that stores executable instructions that cause a machine to:
send an interrogation request using an omni-directional antenna at a secondary surveillance radar;
receive, from responding aircraft, interrogation responses comprising identity and altitude;
determine a distance to each of the responding aircraft based on a time the interrogation request was sent and a time an interrogation response was received;
receive, from a primary radar, positions of tracks;
correlate the distances of each responding aircraft with the positions of the tracks to form a set of candidates by position; and
send identity, altitude and position of a track if there is one candidate from the set of candidates.

13. The article of claim 12, further comprising executable instructions that cause a machine to:
continually receive the interrogation responses and the positions of tracks; and
reduce the set of candidates by position to one candidate.

14. The article of claim 12 wherein the executable instructions that cause a machine to receive, from a primary radar, positions of tracks comprises executable instructions that cause a machine to receive positions of tracks from a primary radar that is a phased array radar having a panel array architecture.

15. The article of claim 12 wherein the executable instructions that cause a machine to receive, from a primary radar, positions of tracks comprises executable instructions that cause a machine to receive positions of tracks from a primary radar that is a rotating radar.

16. The article of claim 12 wherein the executable instructions that cause a machine to determine a distance to each of the responding aircraft based on a time the interrogation request was sent and a time an interrogation response was received comprises executable instructions that cause a machine to determine a distance to each of the responding aircraft based on the time the interrogation request was sent, the time the interrogation response was received and a transponder delay.
